(19) United States
(12) Patent Application Publication
(10) Pub. No.: US 2004/0067479 A1
(43) Pub. Date: Apr. 8, 2004

(54) Method for educating a child

(76) Inventor: Santina Buffone, Dearborn, MI (US)

Correspondence Address: Kevin Shenkman, Suite 3300, 601 S. Figueroa, Los Angeles, CA, 90017, US

(21) Appl. No.: 10/264,097

(22) Filed: Oct. 4, 2002

(51) Int. Cl. G09B 7/00

(52) U.S. Cl. 434/362; 434/236; 434/365

(57) ABSTRACT

A method of educating a child comprising; providing the child with recorded footage of at least one other child performing an academic task, encouraging the child to imitate the recorded child in the completion of the academic task; encouraging an adult primarily responsible for the daily care of the child to become involved in the imitation and education of the child, wherein the encouragement comprises conducting an instructional session with the adult, at which the parent is provided with questions for presentation to the child, and providing the child with interactive materials for facilitating the desired imitation, wherein the recorded footage and interactive materials are provided to the child for use in the child's home.

### BACKGROUND OF THE INVENTION

1. Field of the Invention

The present invention relates generally to multimedia educational tools, such as personal computers, software, and other audio-visual devices. More particularly, the present invention relates to a method for instructing children how to read and reinforcing their attempts to decode text using multimedia tools.

2. Disclosure Information

Recently, President George W. Bush proclaimed that it should be the goal of the United States system of education to ensure that every child reads at grade level by the third grade, and that no child be left behind, regardless of his/her particular circumstances. Presumably, this mandate includes children who are not raised in English-speaking households.

Ordinarily by the time a child enters the first grade, that child has had the benefit of having a parent or another adult read to him/her for at least a number of years. Further, these children are likely to observe a parent reading on her own.

While many of these children cannot decode text in a functional manner and are even less likely to comprehend in an appreciable way what that text means, they learn important skills from observing adults reading. For example, children model the behaviors of their parents and others around them. In so observing, children learn how to position a book, turn its pages from beginning to end, scroll text from left to right and top to bottom. From being read to, children gain an understanding of the chronological order of stories, learn that pictures provide context clues to a story, and learn to associate particular letters with their corresponding sounds to form words.

Elementary school teachers draw upon this set of skills to ultimately teach children to read and comprehend written language. This is customarily done in kindergarten and the first grade.

Children who do not enjoy this set of skills upon entering the first grade typically have more difficulty reading than their peers and often fall behind their classmates in learning to read. Absent some remedial measure, these children may not learn to read in a timely fashion, and as a result will have difficulties in other aspects of their respective educations.

Children who do not possess this set of skills when beginning the first grade are most often those whose parents are not native English speakers or are economically disadvantaged.

Prior art methods and tools for teaching children to read do not address the peculiar obstacles faced by such children. Particularly, the skill set discussed above is presumed, and thus not addressed by the educator.

### SUMMARY OF THE INVENTION

The present invention overcomes the disadvantages associated with the prior art by providing a method of educating a child comprising:

providing the child with recorded footage of at least one other child performing an academic task;

encouraging the child to imitate the recorded child in the completion of the academic task;

encouraging an adult primarily responsible for the daily care of the child to become involved in the imitation and education of the child,

wherein the encouragement comprises conducting an instructional session with the adult, at which the parent is provided with questions for presentation to the child; and

providing the child with interactive materials for facilitating the desired imitation, wherein the recorded footage and interactive materials are provided to the child for use in the child's home.

The present invention further provides an educator with materials that guide the educator in his/her education of a child according to the above method.

It is an advantage of the present invention to provide an improved method and device for educating a child and instructing a child on reading, mathematics, and science.

It is a further advantage of the present invention to provide an improved method and device for educating children not accustomed to functioning in the English language.

It is an even further advantage of the present invention to provide the interactive materials and recording medium to guide an educator and parent in the process of teaching a child how to read or perform other academic tasks.

These and other objects, features and advantages of the present invention will become apparent from the drawings, detailed description and claims which follow.

### BRIEF DESCRIPTION OF THE DRAWINGS

FIG. 1 is a perspective view of the materials used to carry out the method of the present invention.

FIG. 2 is a flow chart of a method embodying the present invention.

### DETAILED DESCRIPTION OF THE PREFERRED EMBODIMENTS

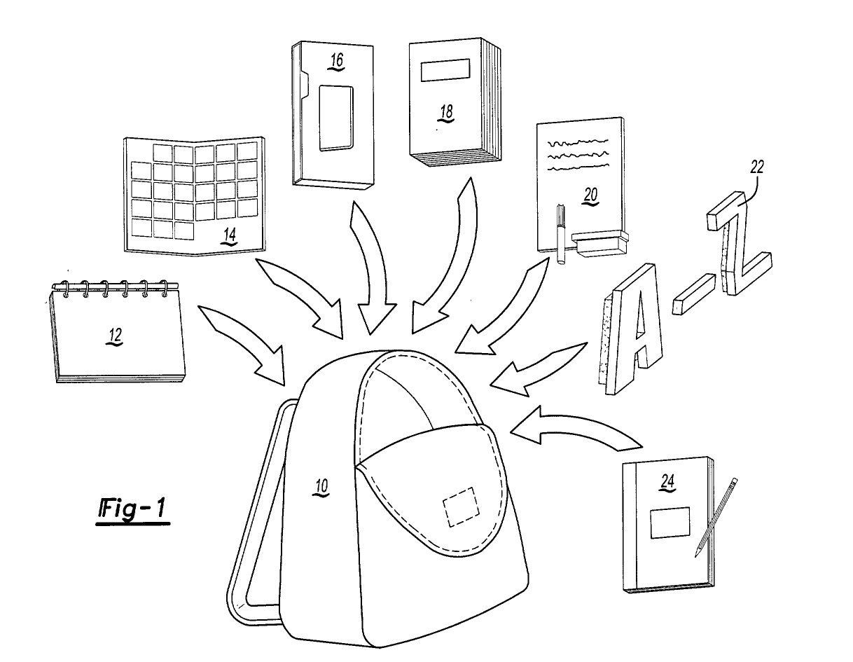

Referring now to the drawings, FIG. 1 shows a bag, such as a backpack 10 containing the interactive materials used by a child to carry out the method of the present invention. These interactive materials include an ABC book 12 of the type well known to those skilled in the art, as well as reinforcing books 18 particularly designed to teach specific literacy skills to young children.

Further included in the backpack 10 is at least one set of magnetic letters 22. The magnetic letters 22 may be used by the child to form words. The magnetic letters 22 also allow the child to become accustomed to the shape and appearance of the letters of the English language. Similarly, the ABC chart 14, while causing the child to become accustomed to the letters of the English language, also teaches the child the sounds each letter is meant to symbolize by providing a characteristic picture. For example the ‘Bb’ section of the chart may have an illustration of a bird, to allow the child to associate the letters to their sounds.

Further, the backpack 10 contains a composition book 24 and dry erase board and accompanying marker 20. These tools 20 and 24 are intended to encourage the child to write, as well as read. The dry erase board and accompanying marker 20 is particularly suited to educational sessions between the child and his/her parent(s).

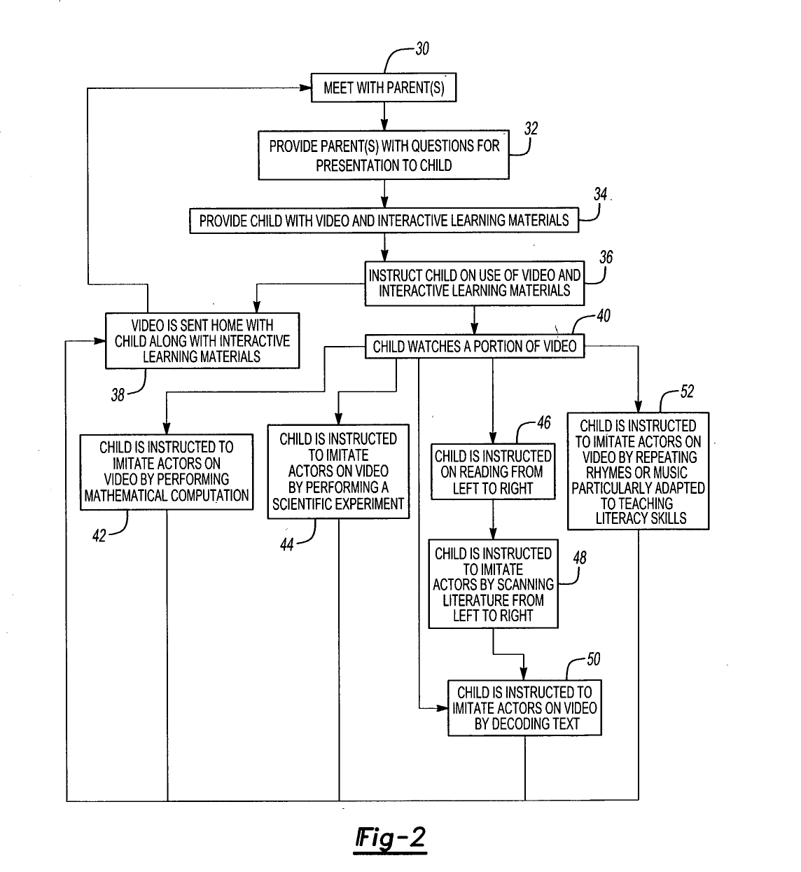

Finally, included in the backpack 10 is a recorded video. The contents of the video will be better understood with reference to FIG. 2 and after reading the remainder of the specification and the claims that follow.

With reference now to FIG. 2, the algorithm depicted is utilized in accordance with the present invention. Ordinarily, the algorithm begins at block 30, at which the educator or administrator of the present invention meets with the parent(s) of the child to be educated. It should be noted that throughout this specification, a parent may be a biological or adoptive parent, or alternatively an adult who is primarily responsible for the care of the child. At this initial meeting with the parent(s) the educator or administrator describes the process to be used in educating the child, namely the present invention. The educator or administrator may further evaluate the relationship between the parent(s) and child, as well as the parent(s) proficiency in the English language.

Then at step 32, the educator or administrator discusses with the parent(s) the necessity for their participation in the method of the present invention. Techniques for interacting with and encouraging the child are suggested to the parent(s) at this initial meeting. Particular questions for presentation to the child may also be provided to the parent(s) at block 32.

The algorithm then continues to block 34. At block 34 the video and interactive materials depicted in FIG. 1 are provided to the child. Alternatively, these materials may be given to the parent(s) for distribution to the child at home. The distribution to the parent(s) may occur at the initial meeting described above.

Moving forward to block 36, the educator or administrator instructs the child on the use of the video and interactive materials distributed at block 34.

Continuing to block 40, the child watches the video. This step can be, and in fact is intended to be, repeated more than once, whether in an educational setting or at the child's home. From block 40, the algorithm continues to block 42, block 44, block 46, block 50, or block 52.

Alternatively, the algorithm may move to block 38. At block 38, the video is sent home with the child along with the interactive learning materials. This is done to reinforce the behavior on the recording medium through multiple viewings, as well as to involve the above mentioned parent(s).

From block 38, the algorithm may return to block 30, where a further meeting with the parent(s) is conducted by the educator or administrator. At this meeting the educator or administrator discusses the proper use of the learning materials at the child's home. The educator or administrator may further encourage the parent(s) to become involved in the child's education.

At block 42, the child is instructed to imitate the actors who appear on the video by performing one or a series of mathematical computations. The child is assisted in performing this task if necessary.

Similarly, at blocks 44, 50, and 52, the child is instructed to imitate the actors who appear on the video by performing a scientific experiment, decoding text, or repeating rhymes or music particularly adapted to teaching literacy skills, respectively. In each of these tasks, the child may be assisted.

If a child is just beginning the process of learning to read, and particularly if the child comes from an economically disadvantaged, or non-English speaking, home, the educator may move to block 46 of the algorithm. At block 46, the child is instructed that English is read from left to right, and from top to bottom.

After this initial instruction, the algorithm proceeds to block 48. At block 48 the child is instructed to imitate the actors who appear on the video by scanning literature, such as a book or newspaper, from left to right, and from top to bottom. After these prerequisites are accomplished, the educator may continue to block 50, as discussed above.

In view of the above, variations and modifications to the present invention will, no doubt, occur to those skilled in the art. For example, the present invention has been described with reference to the English language. However, the same principles of the present invention can be applied to different languages, particularly those in which text is read in a standard direction. It is the following claims, including all equivalents, which define the scope of the invention.

What is claimed is:

1. A method for educating a child comprising:
providing said child with recorded footage of at least one other child performing at least one academic task; and
encouraging said child to imitate said at least one other child in the completion of said at least one academic task.

2. The method of claim 1 further comprising encouraging an adult primarily responsible for the daily care of said child to become involved in said imitation and the education of said child.

3. The method of claim 2 wherein said encouragement comprises conducting an instructional session with said adult, at which said parent is provided with questions for presentation to said child.

4. The method of claim 1 further comprising providing said child with interactive materials for facilitating said imitation.

5. The method of claim 1 wherein said recorded footage is provided to said child for use in said child's home.

6. The method of claim 1 wherein said recorded footage includes instruction relating to all steps used by said at least one child in said completion of said at least one academic task.

7. The method of claim 1 wherein said academic task substantially comprises decoding text.

8. The method of claim 7 wherein said recorded footage is particularly adapted to teaching students accustomed to functioning in a language typically read and written right to left.

9. The method of claim 1 wherein said academic task substantially comprises mathematical computation.

10. The method of claim 1 wherein said academic task substantially comprises a scientific experiment.

11. The method of claim 1 wherein said recorded footage comprises music or rhymes particularly adapted to teaching literacy skills.

12. A device for educating a child comprising:
A medium capable of displaying recorded footage wherein said medium is imprinted with recorded footage of at least one other child performing at least one academic task; and
Recorded footage particularly suited to encouraging said child to imitate said at least one other child in the completion of said at least one academic task.

13. The device of claim 12 wherein said medium is further imprinted with recorded footage particularly suited to encouraging an adult primarily responsible for the daily care of said child to become involved in said imitation and the education of said child.

14. The device of claim 12 further comprising interactive educational materials for use in conjunction with said recorded footage.

15. The device of claim 12 wherein said device is particularly suited for use in the home of said child.

16. The device of claim 12 wherein said medium is further imprinted with instruction relating to all steps used by said in said completion of said at least one academic task.

17. The device of claim 12 wherein said academic task substantially comprises decoding text.

18. The device of claim 12 wherein said academic task substantially comprises mathematical computation.

19. The device of claim 12 wherein said academic task substantially comprises a scientific experiment.

20. The device of claim 17 wherein said device is particularly adapted to teaching students accustomed to functioning in a language typically read and written right to left.
